(19) United States
(12) Patent Application Publication
(10) Pub. No.: US 2002/0168894 A1
(43) Pub. Date: Nov. 14, 2002

(54) Electrical outlet use with Christmas tree

(76) Inventor: Chris Goebel, Broadview Heights, OH (US)

Correspondence Address: EMERSON & SKERIOTIS, Heather M. Barnes, Esq., Fourteenth Floor, One Cascade Plaza, Akron, OH, 44308-1136, US

(21) Appl. No.: 10/143,336

(22) Filed: May 10, 2002

Related U.S. Application Data
(60) Provisional application No. 60/290,162, filed on May 10, 2001.

(51) Int. Cl. H01R 25/00

(52) U.S. Cl. 439/574; 439/112

(57) ABSTRACT

An electrical conduit receptacle is especially useful with a tree, such as a Christmas tree. Tree limbs at various heights above the ground support the receptacle. A plurality of female receivers are configured about its generally circular orientation so that male plugs from associated strands of lights such as Christmas lights can be easily inserted into the female receivers.

### I. BACKGROUND OF THE INVENTION

A. Field of Invention

This invention pertains to the art of electrical outlets, such as surge protection strips, and more particularly to an electrical outlet or surge strip configured especially for use with a Christmas tree.

B. Description of the Related Art

Electrical outlets such as surge strips are known in the art. It is known to configure electrical outlets in a general linear configuration to provide multiple outlets for appliances and the like which receive power from a single wall outlet.

### II. SUMMARY OF THE INVENTION

A non-linear configuration electrical receptacle is provided which is at least partially polygonal in configuration, where the interior diameter of the receptacle if it were completely circular is between six inches and twelve inches. The receptacle may have a hinged point and another point spaced a distance away from the hinged point in which the receptacle is open or partable such that two ends can be separated from one another about the hinge point. Accordingly, it is an object of the present invention to provide an electric receptacle, which enables multiple strings of lights to be easily attached thereto for illuminating an associated object, such as a Christmas tree.

Another object of the present invention is to provide an electric receptacle comprising a non-linear configured body, the body being separable into at least a first portion and a second portion, the body further comprising at least one female receptacle defined therein, the body adapted to surround an associated object.

It is yet another object of the present invention to provide an apparatus further comprising a first end, a second end, and, a hinge mechanism, wherein the first end and the second end define a slot therebetween when one of the ends pivots about the hinge mechanism.

Still, another object of the present invention is to provide an apparatus, wherein the body has an opening defined therein.

Further, another object of the present invention is to provide an apparatus, wherein the associated object is a tree trunk.

Another object of the present invention is to provide an apparatus, further comprising a plurality of female receptacles defined in a top surface of the body.

Further yet, another object of the present invention is to provide an apparatus, further comprising a cord and plug in electrical communication with the body to provide power to the body.

It is yet another object of the present invention is to provide an apparatus, wherein the body has a bottom surface having a plurality of female receptacles.

Still, another object of the present invention is to provide an apparatus, wherein the body is at least partially polygonal in configuration, the body having an interior diameter between six inches and twelve inches.

Further, another object of the present invention is to provide an apparatus, wherein the apparatus has a hinged point, and another point spaced a distance away from the hinged point in which the receptacle is partable such that two ends can be separated from one another about the hinge point.

It is yet another object of the present invention to provide an electric receptacle, comprising a body being at least partially polygonal in configuration, the body having a top surface and a bottom surface, the top surface having at least one female receptacle defined in the top surface, the body adapted to at least partially surround an associated object.

Another object of the present invention to is provide an electrical outlet for use with an associated Christmas tree, the electrical outlet comprising a circular body having a top surface, a bottom surface, an exterior sidewall and an interior sidewall, the body having a plurality of receptacles defined in the top surface, each of the receptacles adapted to receive an associated male plug from a string of lights, the body having an opening defined within the interior sidewall to receive a trunk of the Christmas tree; a hinge mechanism operatively connected to the exterior sidewall so that the body is separable into a first portion and a second portion having first and second ends, respectively, the first and second ends defining a slot therebetween when the first and second portion are separated about the hinge mechanism, the slot being diametrically opposed from the hinge mechanism; and, a cord in electrical communication with the body so as to provide power to each of the female receptacles.

Further, another object of the present invention is to provide a method for using an electrical outlet, comprising the steps of:

providing an electrical outlet having a non-linear configured body, the body being separable into at least a first portion and a second portion, the body further comprising a plurality of female receptacles defined therein, the body adapted to surround an associated object;

attaching the body to the object;

attaching at least one strand of associated lights to the female receptacle; and

powering the female receptacle to illuminate the lights.

Still, another object of the present invention to is provide an apparatus, wherein attaching the body to the object further comprises the steps of:

providing a hinge mechanism on the body so that the body may be separated into a first and a second portion;

pivoting the first portion about the hinge mechanism so that a slot is defined between the first and second portions;

pivoting said first portion about said hinge mechanism to close said slot; and,

securing said first and second portions together.

However, to this point it has not been known to provide a circular shaped outlet receptacle that is hinged to allow its use within the midst, or at either end, of the Christmas tree.

Still other benefits and advantages of the invention will become apparent to those skilled in the art to which it pertains upon a reading and understanding of the following detailed specification.

### III. BRIEF DESCRIPTION OF THE DRAWING

The invention may take physical form in certain parts and arrangement of parts, a preferred embodiment of which will be described in detail in this specification and illustrated in the accompanying drawings which form a part hereof and wherein:

FIG. 1 is a schematic plan view of an outlet receptacle according to the invention;

FIG. 2 is a schematic bottom view of the outlet receptacle;

FIG. 3 is an elevational view of the present invention shown in FIG. 1;

FIG. 4 is a top schematic plan view of the invention in the open position; and,

FIG. 5 is a top schematic plan view of another embodiment of the invention in the open position.

### IV. DESCRIPTION OF THE PREFERRED EMBODIMENT

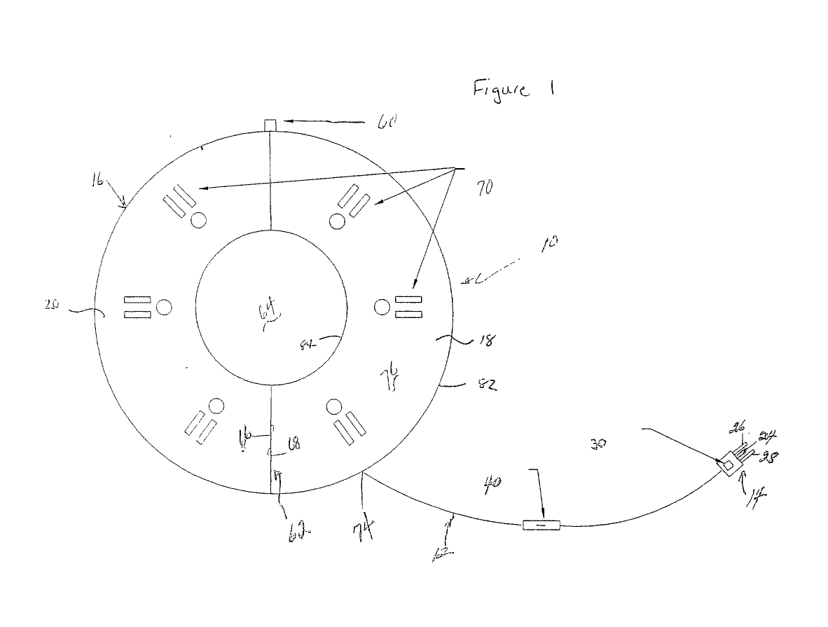

Referring now to the drawings wherein the showings are for purposes of illustrating a preferred embodiment of the invention, only, and not for purposes of limiting the same, with reference to FIGS. 1-5, an apparatus, namely, a electric receptacle 10 according to the invention is shown. The electric receptacle 10 in the preferred embodiment features a generally circular, ring-like, configuration. While this is the preferred configuration of the invention, other configurations have been contemplated by the inventor and are within the scope of the invention. For example, polygonal, semi-circular, partially circular or triangular embodiments have been contemplated. Essentially, any non-linear design is to be considered within the scope of the invention.

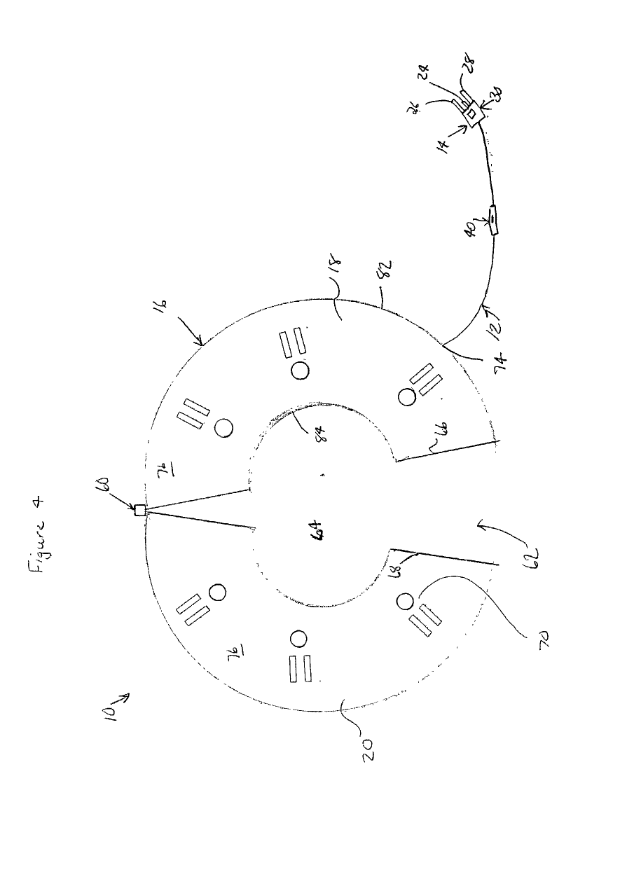

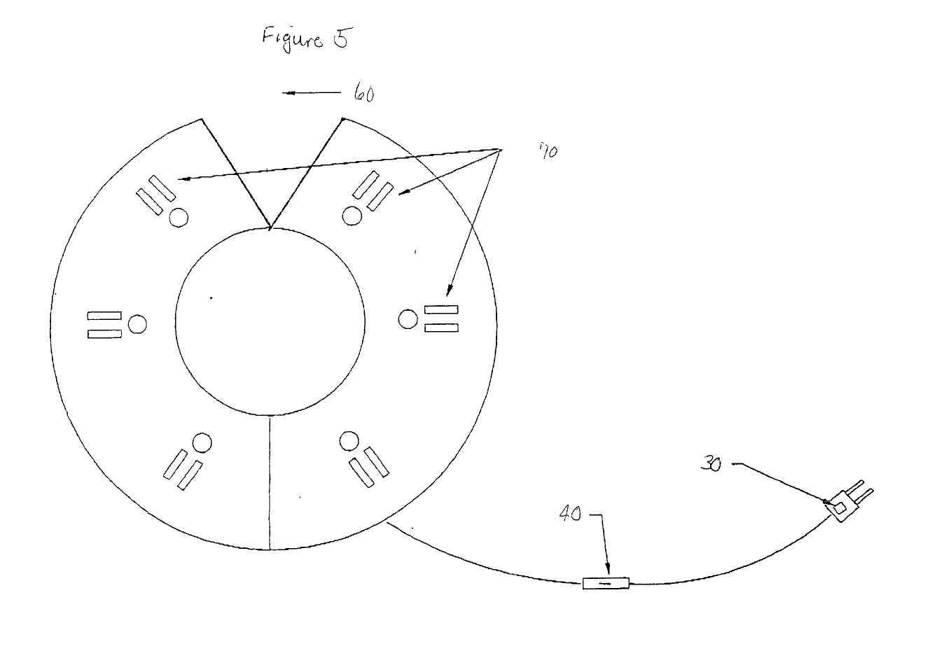

With reference to FIGS. 1-5, the electric receptacle 10 comprises a body 10 of the configuration shown above. The body comprises a top surface 76 and a bottom surface 78. Further, the body 10 comprises an interior sidewall 82 and an exterior sidewall 84 positioned between the top and bottom surfaces 76, 78. The body 10 is separable into at least a first portion 18 and a second portion 20. The first and second portions 18, 20 are interconnected through a hinge mechanism 60. When the first and second portions 18, 20 pivot about the hinge mechanism 60, a slot 62 is defined. The hinge mechanism 60 can be of any configuration or hinge that is known in the art, chosen with sound engineering judgment. The hinge mechanism 60 simply operates to allow the invention to move from a closed position, as illustrated in FIG. 1, to an open position, as shown in FIG. 4. FIG. 5 illustrates another way of opening the electric receptacle 10 through the hinge mechanism 60. The slot 62 enables the opening 64 to be used, in that the slot 62 is essentially the interface between a first end 66 and a second end 68, which when moved apart by pivoting about the hinge mechanism 60 allows access to the opening 64.

With continuing reference to FIGS. 1-3, the electric receptacle 10 includes a cord 12 having a plug 14 which is operatively, selectively received in an associated wall outlet, not illustrated. In the preferred embodiment, the plug includes a ground 24 in addition to the normal two prongs 26, 28. Of course, other configurations of plugs will be considered within the scope of the invention. For example, in Europe, where different such plugs are designed, the configuration would be different.

With continuing reference to FIGS. 1-3, a circuit breaker 30 is included in the cord 12, preferably in the plug 14. The circuit breaker 30 protects the user as well as the tree against surges in electricity. Other similar safety devices might be incorporated into the invention. For example, it is well known in the art for certain sorts of ground fault indicating devices and other safety devices to be used in an environment where safety is of special note. When the invention is used with a natural Christmas tree, these type devices could be considered for the unit so as to perhaps lessen the risk of shock or fire.

With continuing reference to FIGS. 1-3, a switch 40 is also included in the cord 12. The switch 40 is also of construction and configuration known in the art. Its position along the cord 12 is to be considered for the convenience of the user. One logical place to put the switch 40 is near the plug 14, since that location is probably near a wall and easily accessible for the user. Locating the switch 40 in this area lessens the likelihood of the forearm of the user being stuck with the needles of an associated tree.

With reference to FIGS. 1-5, the operation of the invention will now be disclosed. In a typical Christmas tree situation, strings of lights are wrapped around the tree at various heights. These strings of lights are generally fairly short, necessitating as many as four to ten strings of lights needing to be hooked together and arranged around the tree. Many of these strings of lights have a plug at one end and a female receptacle at the other send so that they can be hooked together. In some cases, a failure in one of the light strands results in power failure to the remaining lights. In addition, sometimes the electrical load placed on these strands can be unnecessarily close to their technical limits. For example, if many strings of lights are hooked end to end in series, it is conceivable that the voltage and amperage situation facing each of the strings of lights might be different than if each light was independently connected to a source of power such as a wall outlet and or one of the female receptacles 70 in FIGS. 1-4.

For these and other reasons, certain advantages are obtainable by utilizing the invention 10 in the manner to be described.

With continuing reference to FIGS. 1-4, the invention is shown in a circular orientation, best for use at the bottom of a Christmas tree where there are no branches. While the invention can be used at the bottom of the Christmas tree, or at the top, or at some other relationship along the access of the trunk of the Christmas tree, it is believed that for the averaged size Christmas tree, the preferred location would be in the middle. For larger trees, such as might be used in a shopping mall or in large homes, more than one of the inventive electric receptacles 10 might be used. In such a situation, the inventive electric receptacles 10 might be spaced evenly along the trunk of the tree.

With continuing reference to FIGS. 1-5, the preferred method of installing the inventive electrical receptacle 10 will now be described.

First, the portion of the inventive electric receptacle 10 in which the cord 12 interfaces with the receptacle 10 is located. Ideally, this point 74 would be closest to a wall outlet. Next, the slot 62 is widened by separating the first end 66 from the second end 68 of the inventive receptacle 10. A gap is created which should be open wide enough to receive between the first and second ends 66, 68 of the receptacle 10 an associated trunk of a Christmas tree. After the trunk of the Christmas tree is received within the inventive receptacle 10, the first and second ends 66, 68 of the receptacle should be brought together again. A closing device, not illustrated, can be utilized to lock the first and second ends together 66, 68. The closing device may be any mechanism chosen in accordance with sound engineering judgment. The inventive receptacle 10 is supported at its elevation by the floor, tree stand, or tree limbs that jut out from the tree trunk at approximately right angles.

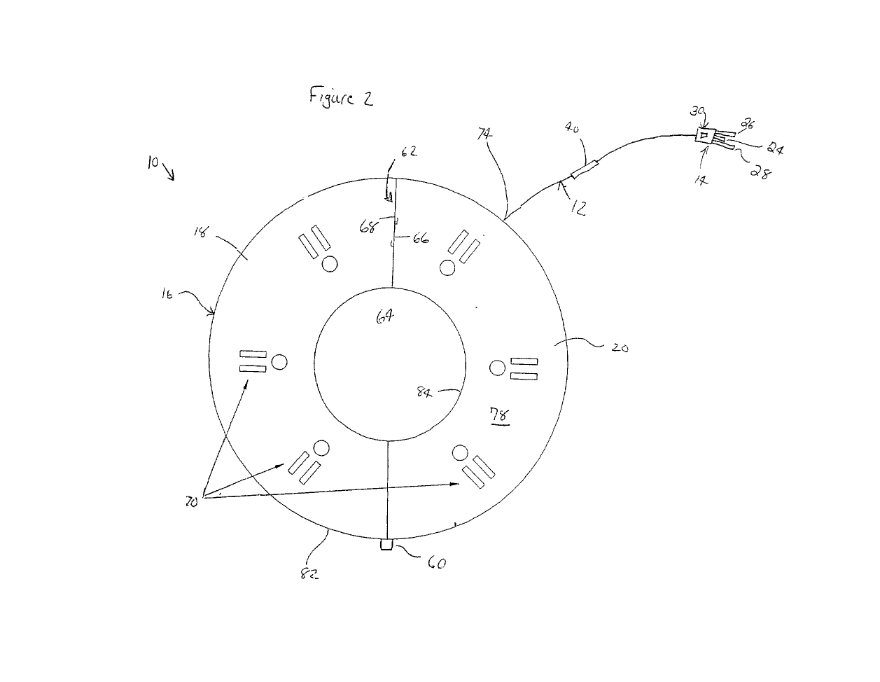

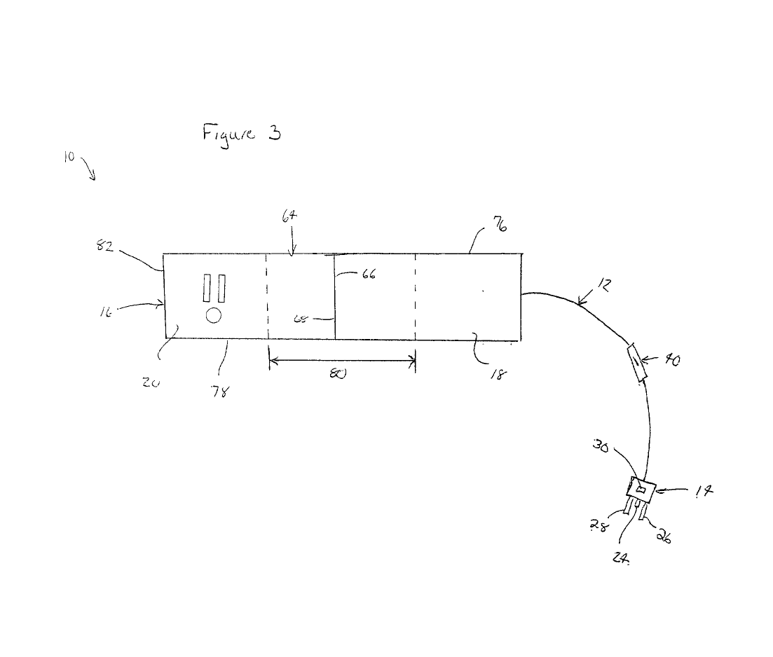

Returning to FIGS. 1-5, the top surface 76 of the inventive receptacle 10 features a plurality of female receptacles 20 into which male plugs of the individual light strands can be inserted. In a preferred embodiment, the bottom surface 78 and/or the exterior sidewall 82 of the inventive receptacle may also have receptacles, as best seen in FIGS. 2 and 3. The relative distance between the male plug of the light strands and the female receptacle 70 on the inventive receptacle 10 is at minimum due to the invention.

Another benefit of the invention is that the electrical interface between the male plugs and the female receptacles is elevated above where children and pets might normally operate under the Christmas tree.

The invention has been described with reference to preferred embodiment. Obviously, modifications and alterations will occur to others upon a reading and understanding of this specification. It is intended to include all such modifications and alternations in so far as they come within the scope of the appended claims or the equivalence thereof.

Having thus described the invention, it is now claimed:

I claim:

1. An apparatus, comprising:
a non-linear configured body, said body being separable into at least a first portion and a second portion, said body further comprising at least one female electric receptacle defined therein, said body adapted to surround an associated object.

2. The apparatus of claim 1, wherein said body further comprises:
a first end;
a second end; and,
a hinge mechanism, wherein said first end and said second end define a slot therebetween when one of said ends pivots about said hinge mechanism.

3. The apparatus of claim 1, wherein said body has an opening defined therein.

4. The apparatus of claim 1, wherein the associated object is a tree trunk.

5. The apparatus of claim 1, further comprising a plurality of female electric receptacles defined in a top surface of said body.

6. The apparatus of claim 1, further comprising a cord and plug in electrical communication with said body to provide power to said body.

7. The apparatus of claim 1, wherein said body has a bottom surface having a plurality of female electric receptacles.

8. The apparatus of claim 1, wherein, said body is at least partially polygonal in configuration, said body having an interior diameter between six inches and twelve inches.

9. The apparatus of claim 1 having a hinged point and another point spaced a distance away from said hinged point in which the receptacle is partable such that two ends can be separated from one another about said hinge point.

10. An electric receptacle, comprising:
a body being at least partially polygonal in configuration, said body having a top surface and a bottom surface, said body having at having at least one female receptacle defined therein, said body adapted to at least partially surround an associated object.

11. The electric receptacle of claim 10, wherein said body is separable into a first portion and a second portion through a hinge mechanism.

12. The electric receptacle of claim 10, wherein said body is adapted to surround a tree trunk.

13. The electric receptacle of claim 10, further comprising a plurality of female receptacles defined in said top surface.

14. The electric receptacle of claim 10, wherein said bottom surface has at least one female receptacle defined therein.

15. The electric receptacle of claim 10, wherein said body further comprises a sidewall positioned between said top and bottom surfaces, said sidewall having at least one female receptacle defined therein.

16. The electric receptacle of claim 10, further comprising a cord operatively connected to said body to provide power to said female receptacle.

17. An electrical outlet for use with an associated Christmas tree, the electrical outlet comprising:
a circular body having a top surface, a bottom surface, an exterior sidewall and an interior sidewall, said body having a plurality of receptacles defined in said top surface, each of said receptacles adapted to receive an associated male plug from a string of lights, said body having an opening defined within said interior sidewall to receive a trunk of the Christmas tree;
a hinge mechanism operatively connected to said exterior sidewall so that said body is separable into a first portion and a second portion having first and second ends, respectively, said first and second ends defining a slot therebetween when said first and second portions are separated about said hinge mechanism, said slot being diametrically opposed from said hinge mechanism; and,
a cord in electrical communication with said body so as to provide power to each of said female receptacles.

18. The electrical outlet of claim 17, wherein said bottom surface of said body further comprises a plurality of female receptacles defined therein.

19. The electrical outlet of claim 17, wherein said exterior sidewall of said body further comprises a plurality of female receptacle for receiving the male plug from the string of lights.

20. A method for using an electrical outlet, comprising the steps of:
providing an electrical outlet having a non-linear configured body, said body having a first portion and a second portion, said body further comprising a plurality of female receptacles defined therein, said body adapted to surround an associated object;
attaching said body to the object;
attaching at least one strand of associated lights to said female receptacle; and
powering said female receptacle to illuminate the lights.

21. The method of claim 20, wherein attaching said body to the object further comprises the steps of:
providing a hinge mechanism on said body so that said body may be separated into said first and second portions;
pivoting said first and second portions about said hinge mechanism so that a slot is defined between said first and second portions;
pivoting said first and second portions about said hinge mechanism to close said slot; and,
securing said first and second portions together.
